(19) United States
(12) Patent Application Publication
(10) Pub. No.: US 2008/0295531 A1
(43) Pub. Date: Dec. 4, 2008

(54) METHOD TO CONTROL SLEEP OPERATION OF AIR CONDITIONER

(75) Inventors: Myung Seob Song, Hwaseong-si (KR); Hyung Chel Kim, Busan (KR); Kook Geong Seo, Yongin-si (KR); Seung Chul Shin, Suwon-si (KR); Yong Gak Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/937,757

(22) Filed: Nov. 9, 2007

(30) Foreign Application Priority Data
May 29, 2007 (KR) 10-2007-0052074
Nov. 6, 2007 (KR) 10-2007-0112564

(51) Int. Cl. G05D 23/00; F25B 13/00

(52) U.S. Cl. 62/157; 62/160

(57) ABSTRACT

A method to control the sleep operation of an air conditioner is provided. The method includes determining whether or not a sleep operation is activated and sequentially performing a plurality of sub-modes of the sleep operation when the sleep operation is activated.

### CROSS-REFERENCE TO RELATED APPLICATION

This application claims the benefit of Korean Patent Application No. 10-2007-0052074, filed on May 29, 2007 in the Korean Intellectual Property Office, and Korean Patent Application No. 10-2007-0112564, filed Nov. 6, 2007 in the Korean Intellectual Property Office, the disclosures of which is are incorporated herein by reference.

### BACKGROUND OF THE INVENTION

1. Field of the Invention

The present invention relates to a method to control a sleep operation of an air conditioner, and more particularly, to a method to control a sleep operation of an air conditioner in which an indoor temperature is automatically changed in the sleep operation to allow the user to sleep soundly.

2. Description of the Related Art

A conventional air conditioner performs cooling and heating operations to cool and heat indoor air to keep the air at a target indoor temperature selected by the user, thereby providing a comfortable room environment to the user. However, when the user sleeps during the cooling operation, the user may feel cold after a certain time elapses from the start of the cooling operation. This is because the air conditioner operates with only the initially set target indoor temperature throughout the cooling operation. Alternatively, the user may feel hot if the cooling operation is turned off, thereby failing to provide a comfortable sleep environment. On the other hand, when the user sleeps during the heating operation, the user may feel hot after a certain time elapses from the start of the heating operation since the air conditioner operates with only the initially set target indoor temperature throughout the heating operation, and may feel cold if the heating operation is turned off, thereby failing to provide a comfortable sleep environment.

FIG. 1 illustrates the characteristics of sleep states in which non-REM and REM sleep periodically alternate. As shown in FIG. 1, every human being alternately undergoes non-REM and REM sleep 4 or 5 times at intervals of about 90 minutes per night. It can be seen from FIG. 1 that the deepest sleep is a non-REM sleep immediately after falling asleep. The cold or hot feeling and the metabolic rate of the human being depend on the amount of heat generated from the skin. The human being feels colder as the metabolic rate decreases. FIG. 2 illustrates the characteristics of changes in the metabolic rate of human beings until waking up after falling asleep. After falling asleep, the metabolic rate of human beings is reduced to fall into a non-REM sleep, as shown in FIG. 2. When falling into a deep sleep from a shallow sleep, the body temperature of human beings is significantly reduced, causing serious perspiration. The perspiration causes the human being to feel hot and uncomfortable, thereby making it difficult to fall into a deep sleep.

To overcome these problems, Japanese Patent Application Publication No. 2004-92918 suggested an air conditioner which reduces the indoor temperature to be lower than a target indoor temperature set by the user at an initial stage in a preset sleep operation duration to allow fast falling asleep, taking into consideration the sleep state characteristics of FIG. 1 and the changes in the metabolic rate of human beings during sleep. When the user has fallen asleep, the metabolic rate and activity is reduced so that the sleeper easily feels cold. Therefore, after the user falls asleep, the air conditioner gradually increases the indoor temperature to allow the user to sleep soundly.

However, this conventional method to control a sleep operation of an air conditioner does not take into consideration the sleep operation duration desired by the user and performs sleep operation control based on 8 hours, which is the average sleep time, thereby failing to achieve efficient sleep operation control.

In addition, in the intermediate and final stages of the sleep operation, the indoor temperature becomes higher than the preset target temperature to increase the skin temperature of the user, thereby disturbing their sound sleep.

Further, the conventional air conditioner provides the sleep operation only for cooling, thereby failing to satisfy the user's desire for the sleep operation for heating.

### SUMMARY OF THE INVENTION

Therefore, it is an aspect of the present invention to provide a method to control a sleep operation of an air conditioner, wherein an indoor temperature is automatically changed in the sleep operation to allow the user to sleep soundly.

Additional aspects and/or advantages of the present invention will be set forth in part in the description which follows and, in part, will be apparent from the description, or may be learned by practice of the invention.

The foregoing and/or other aspects of the present invention may be achieved by providing a method to control a sleep operation of an air conditioner, the method including determining whether or not a sleep operation is activated; and sequentially performing a plurality of sub-modes of the sleep operation if the sleep operation is activated.

The plurality of sub-modes include a falling-asleep mode to reduce an indoor temperature to be lower than a target indoor temperature by a first level and a waking mode to increase the indoor temperature to be higher than the target indoor temperature by a second level.

The plurality of sub-modes further include a deep sleep mode to increase the indoor temperature to be higher than the target indoor temperature by the first level and then to reduce the indoor temperature back to the target indoor temperature periodically during the cooling operation.

The plurality of sub-modes further include a deep sleep mode to increase the indoor temperature to the target indoor temperature after maintaining the indoor temperature at a level, which is lower than the target indoor temperature by the first level, during the heating operation.

The deep sleep mode includes repeating an operation to reduce, when the indoor temperature has reached the target indoor temperature, the indoor temperature back to a temperature, which is lower than the target indoor temperature by the second level, and then to increase the indoor temperature back to the target indoor temperature.

An operation duration of the deep sleep mode is determined according to a duration of the sleep operation.

The second level is higher than the first level during the cooling operation.

In the falling-asleep mode during cooling operation, when a sleep operation command is input, the air conditioner immediately operates with a temperature which is lower than the target indoor temperature by the first level.

The second level is lower than the first level during the heating operation.

In the falling-asleep mode during the heating operation, when a sleep operation command is input, the air conditioner operates with the target indoor temperature for a specific period of time and then operates with a temperature which is lower than the target indoor temperature by the first level.

The foregoing and/or other aspects of the present invention may also be achieved by providing a method to control a sleep operation of an air conditioner when the air conditioner is in a cooling operation, the method including maintaining an indoor temperature during a falling-asleep mode comprising maintaining the indoor temperature below a target indoor temperature until a first reference time elapses after the sleep operation starts, increasing the indoor temperature during a deep sleep comprising increasing, after the first reference time elapses, the indoor temperature to be higher than the target indoor temperature and then reducing the indoor temperature back to the target indoor temperature periodically, and maintaining the indoor temperature during a waking mode comprising maintaining the indoor temperature above the target indoor temperature for the first reference time before the sleep operation is terminated.

The first reference time is 1 hour.

The target indoor temperature is set within a range from 24° C. to 27° C.

The indoor temperature is maintained below the target indoor temperature by 2° C. until the first reference time elapses from the start of the sleep operation, the indoor temperature is increased to be 2° C. higher than the target indoor temperature and then reduced back to the target indoor temperature periodically after the first reference time elapses, and the indoor temperature is maintained above the target indoor temperature by 2.5-3° C. for the first reference time before the sleep operation is terminated.

The foregoing and/or other aspects of the present invention may also be achieved by providing a method to control a sleep operation of an air conditioner when the air conditioner is in the heating operation, the method including maintaining an indoor temperature below a target indoor temperature by a first level until a first reference time elapses after the sleep operation starts, and increasing, after the first reference time elapses, the indoor temperature to be higher than the target indoor temperature by a second level during a remaining time of the sleep operation.

The target indoor temperature is set within a range from 22° C. to 25° C.

The first level is 2° C. and the second level is 1° C.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the characteristics of sleep states in which non-REM and REM sleep periodically alternate;

FIG. 2 illustrates the characteristics of changes in the metabolic rate of human beings until they wake up after falling asleep;

FIG. 3 is a block diagram of an air conditioner according to an embodiment of the present invention;

FIG. 4 is a flow chart of a method to control the sleep operation of the air conditioner according to an embodiment of the present invention;

FIG. 5A illustrates changes in a target indoor temperature according to sleep operation timings during cooling operation of the air conditioner according to an embodiment of the present invention;

FIG. 5B illustrates changes in an indoor temperature according to sleep operation timings during the cooling operation of FIG. 5A;

FIG. 6A illustrates changes in a target indoor temperature according to sleep operation timings during heating operation of the air conditioner according to an embodiment of the present invention; and

FIG. 6B illustrates changes in an indoor temperature according to sleep operation timings during the heating operation of FIG. 6A.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

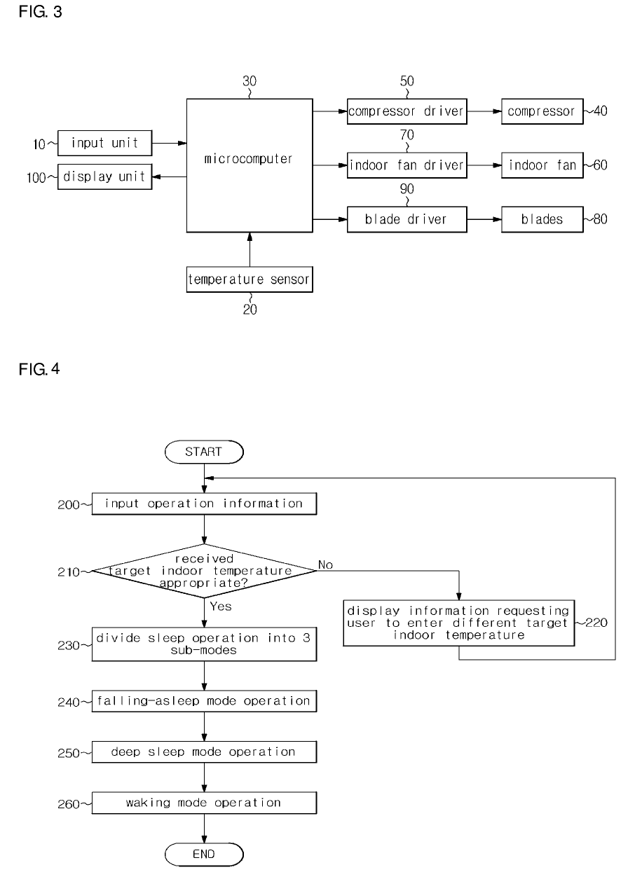

As shown in FIG. 3, an air conditioner according to an embodiment of the invention includes an input unit 10, a temperature sensor 20, and a microcomputer 30. The input unit 10 receives operation information such as a cooling or heating operating mode, a sleep operation duration, and a target indoor temperature from a user. The temperature sensor 20 measures indoor temperature. The microcomputer 30 controls the sleep operation according to the operation information received from the input unit 10. The air conditioner further includes a compressor 40, a compressor driver 50, an indoor fan 60, an indoor fan driver 70, blades 80, and a blade driver 90. The compressor 40 discharges high-temperature refrigerant. The compressor driver 50 drives the compressor 40. The indoor fan 60 blows air, which has undergone heat exchange through an indoor heat exchanger, into the room. The indoor fan driver 70 drives the indoor fan 60. The blades 80 control the flow of discharged air. The blade driver 90 drives the blades 80.

The microcomputer 30 controls each driver according to received operation information to control the sleep operation of the air conditioner. When a sleep operation starts, the microcomputer 30 receives an indoor temperature through the temperature sensor 20 and controls the indoor temperature using a sleep operation algorithm according to each operation mode.

If the user inputs a too high or too low target indoor temperature, the user feels hot or cold during sleep. To prevent this, during a cooling operation, the microcomputer 30 causes a display unit 100 to display information requesting the user to enter the target indoor temperature within a range of 24 to 27° C. On the other hand, during heating operation, the microcomputer 30 causes a display unit 100 to display information requesting the user to enter the target indoor temperature within a range of 22 to 25° C. The reason why the target indoor temperature range is different depending on the operation mode is that the human body reacts differently to seasonal temperature characteristics. For example, human beings are susceptible to diseases such as the common cold if the difference between indoor and outdoor temperatures is too high in summer or winter. Thus, it is desirable that a target indoor temperature during sleep operation of the air conditioner in summer be set to be higher than that of winter by a predetermined level.

The sleep operation is divided into three sub-modes with different operation durations and different indoor temperatures. The sub-modes include a falling-asleep mode in which the indoor temperature is reduced to allow the user to quickly fall asleep, a deep sleep mode in which the indoor temperature is controlled to allow the user to fall into a deep sleep, and a waking mode in which the indoor temperature is controlled to increase the body temperature of the user before they waking.

The operation durations of the falling-asleep mode and the waking mode are preset in the microcomputer 30 and the operation duration of the deep sleep mode is set to be equal to a time left after subtraction of the sum of the operation durations of the falling-asleep mode and the waking mode from a sleep operation duration input by the user. For example, the operation duration of the deep sleep mode (the second section) is 6 hours if each of the preset operation durations of the falling-asleep mode and the waking mode is 1 hour and the sleep operation duration input by the user is 8 hours, whereas it is 7 hours if each of the preset operation durations of the falling-asleep mode and the waking mode is 1 hour and the sleep operation duration input by the user is 9 hours.

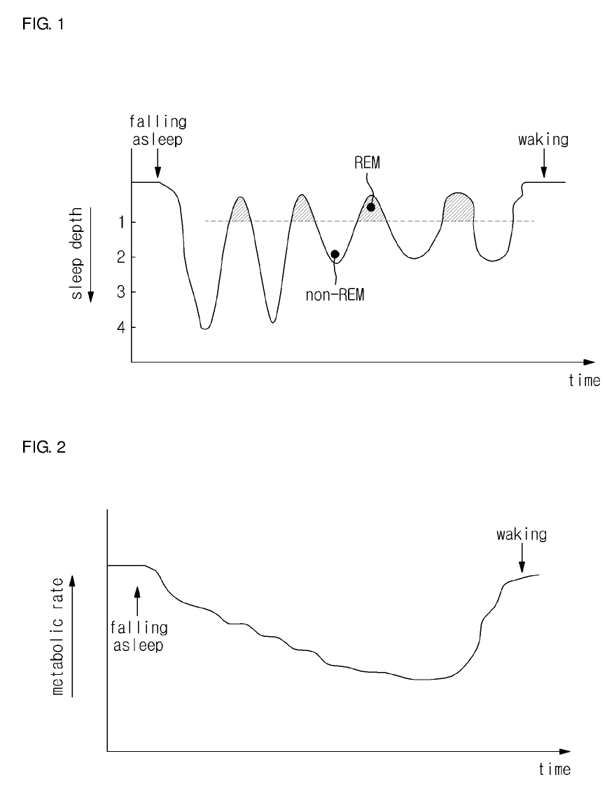

The target indoor temperature data of each sub-mode is set to be different depending on the operation mode in the microcomputer 30. The target indoor temperature data is set based on seasonal temperature characteristics and changes in the body temperature in sleep cycles of human beings, shown in FIGS. 1 and 2.

Target indoor temperature data for the falling-asleep mode of the cooling operation is set to reduce the indoor temperature for a specific time in the initial stage of the sleep operation to allow the user to fall into a deepest sleep (3rd and 4th stages of Non-REM sleep). When the user has fallen asleep, the metabolic rate and activity are significantly reduced, resulting in a cold feeling. Therefore, target indoor temperature data for the deep sleep mode is set to increase the indoor temperature by a specific level in order to provide the user with a comfortable sleep environment in the deep sleep mode. The increase in the indoor temperature may make the user feel hot, thereby disturbing comfortable sleep, so that the target indoor temperature data for the deep sleep mode is set to repeatedly reduce the indoor temperature back to the target indoor temperature initially input by the user. Finally, if the sleep operation is terminated and the user wakes up, then body temperature is low and metabolic activity is low. Therefore, target indoor temperature data for the waking mode is set to further increase the indoor temperature by a specific level in order to increase the body temperature of the user for a specific time before the sleep operation is terminated.

Target indoor temperature data for the falling-asleep mode of the heating operation is set to reduce the indoor temperature for a specific time in the initial stage of the sleep operation to allow the user to fall into a deepest sleep (3rd and 4th stages of Non-REM sleep). Since the indoor temperature in winter is often lower than the target indoor temperature input by the user, the indoor temperature in the falling-asleep mode of the heating operation is reduced after the heating operation is performed to maintain the indoor temperature at the target indoor temperature input by the user for a specific time. Target indoor temperature data for the deep sleep mode is set to maintain the reduced indoor temperature for a specific time so that the user can maintain healthy body/skin temperature during sleep in winter and then to gradually increase the indoor temperature to the target indoor temperature input by the user for the remaining time of the deep sleep mode. Finally, if the sleep operation is terminated and the user wakes up, then the body temperature is low and metabolic activity is low. Therefore, target indoor temperature data for the waking mode is set to further increase the indoor temperature by a specific level in order to increase the body temperature of the user for a specific time before the sleep operation is terminated.

A method to control the sleep operation of the air conditioner according to an embodiment of the invention will now be described with reference to FIG. 4.

If the user inputs operation information for the sleep operation such as an operation mode, a sleep operation duration, and a target indoor temperature, the microcomputer 30 receives the input operation information (200).

If the microcomputer 30 receives the operation information in operation 200, the microcomputer 30 determines whether or not the input target indoor temperature is appropriate for the operation mode (210).

If it is determined in operation 210 that the input target indoor temperature is not appropriate for the operation mode, the microcomputer 30 controls the display unit 100 to display information requesting the user to input a different target indoor temperature within a range of 24 to 27° C. in the case of the cooling mode and within a range of 22 to 25° C. in the case of the heating mode (220).

If it is determined in operation 210 that the input target indoor temperature is appropriate for the operation mode, the microcomputer 30 divides an input sleep operation duration into respective operation durations of the three sub-modes, taking into account changes in the body temperature in sleep cycles of human beings (230).

If the sleep operation duration is divided into the respective operation durations of the sub-modes, in the cooling mode, the microcomputer 30 performs a falling-asleep mode to adjust the indoor temperature to be 2° C. lower than the target indoor temperature to allow the user to quickly fall asleep. In the heating mode, the microcomputer 30 performs a falling-asleep mode to adjust the indoor temperature to be 2° C. lower than the target indoor temperature to allow the user to quickly fall asleep after maintaining the indoor temperature at the target indoor temperature for a specific time. In the falling-asleep mode, the microcomputer 30 increases the rotation speed of the fan and the capacity of the compressor 40 to reduce the indoor temperature in a short time. If the indoor temperature is reduced, the skin temperature of the user is also reduced to allow the user to easily fall asleep and to fall into a deep sleep in a short time (240).

If the operation duration of the falling-asleep mode is terminated, the microcomputer 30 determines that the user has fallen asleep and performs a deep sleep mode to allow the user to sleep soundly. In the cooling mode, the microcomputer 30 performs a deep sleep mode to periodically repeat an operation to increase the indoor temperature to be 2□ higher than the target indoor temperature and then to reduce the indoor temperature back to the target indoor temperature. In the heating mode, the microcomputer 30 performs a deep sleep mode to maintain the reduced indoor temperature for a specific time so that the user can maintain healthy body/skin temperature during sleep in winter and then to gradually increase the indoor temperature to the target indoor temperature input by the user for the remaining time of the deep sleep mode (250).

If the operation duration of the deep sleep mode is terminated, the microcomputer 30 determines that the waking time of the user has been reached and performs a waking mode. In the cooling mode, the microcomputer 30 performs a waking mode to increase the indoor temperature to be 2.5 or 3□ higher than the target indoor temperature to increase the body temperature of the user, and then terminates the operation. In the heating mode, the microcomputer 30 performs a waking mode to increase the indoor temperature to be 1□ higher than the target indoor temperature to increase the body temperature of the user, and then terminates the operation. Increasing the indoor temperature increases the body temperature of the user and increases the metabolic activity of the user (260).

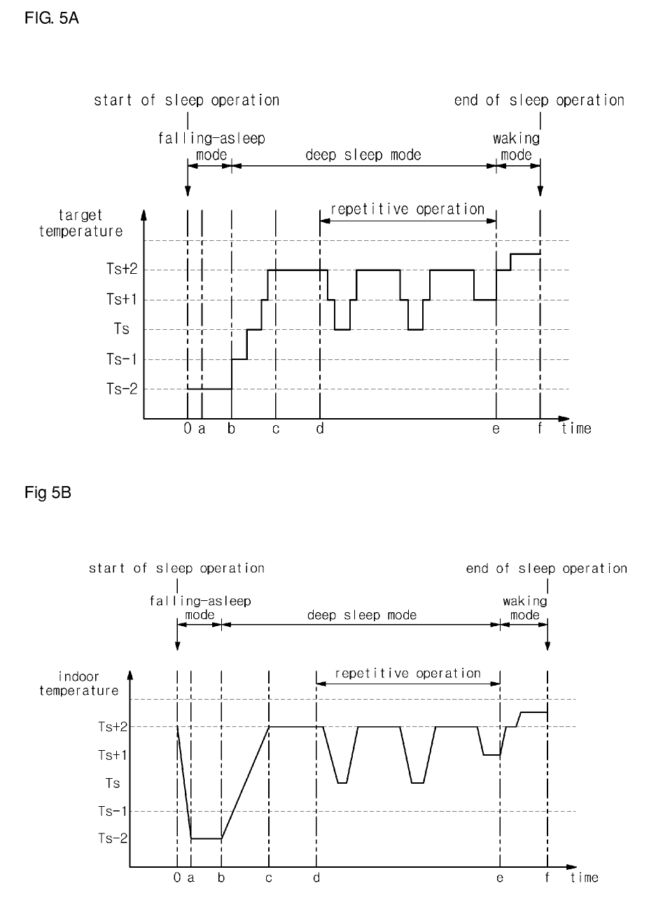

Changes in the indoor temperature according to sleep operation timing during cooling operation of the air conditioner according to an embodiment of the invention will now be described with reference to FIGS. 5A and 5B. When the sleep operation starts, the microcomputer 30 causes the air conditioner to uniformly blow out air at a temperature 2□ lower than the target indoor temperature Ts into the room during a time interval from “0” to “b”, as shown in FIG. 5A. The indoor temperature is rapidly reduced during a time interval from “0” to “a”. This reduces the skin temperature of the user to an appropriate level, thereby minimizing the activity of the temperature control system. Thereafter, the reduced indoor temperature is maintained constant during a time interval from “a” to “b”. This keeps the skin temperature of the user at a lower level to allow the user to fall asleep.

During a time interval from “b” to “c”, the microcomputer 30 gradually increases the temperature of discharged air from that of the time interval from “0” to “b” in order to increase the indoor temperature to a level of “Ts+2”. Here, the indoor temperature is continuously and gradually increased to prevent a rapid increase in the body/skin temperature. The increased indoor temperature prevents a reduction in the skin temperature to allow the user to sleep soundly. During a time interval from “c” to “e”, the microcomputer 30 performs a control operation to increase the indoor temperature to “Ts+2” and then to reduce the temperature to “Ts” in an alternating fashion so that the body/skin temperature is within a comfortable range. Keeping the indoor temperature at the high level “Ts+2” during the time interval from “c” to “e” makes the user feel hot, thereby disturbing comfortable sleep. Thus, it is necessary to periodically reduce the increased indoor temperature.

During a time interval from “e” to “f”, the microcomputer 30 causes the air conditioner to blow out air at a temperature of “Ts+2” into the room for a specific time and then to blow out air at a temperature of “Ts+2.5” or “Ts+3”, which is a specific level (i.e., 2 or 3□) higher than “Ts+2”. Since the user will wake up at the time “f”, the microcomputer 30 further increases the indoor temperature by the specific level to increase the body temperature of the user for a specific time before the time “f” (i.e., during the time interval “e” to “f”). The increased body temperature contributes to increasing the metabolic activity of the user.

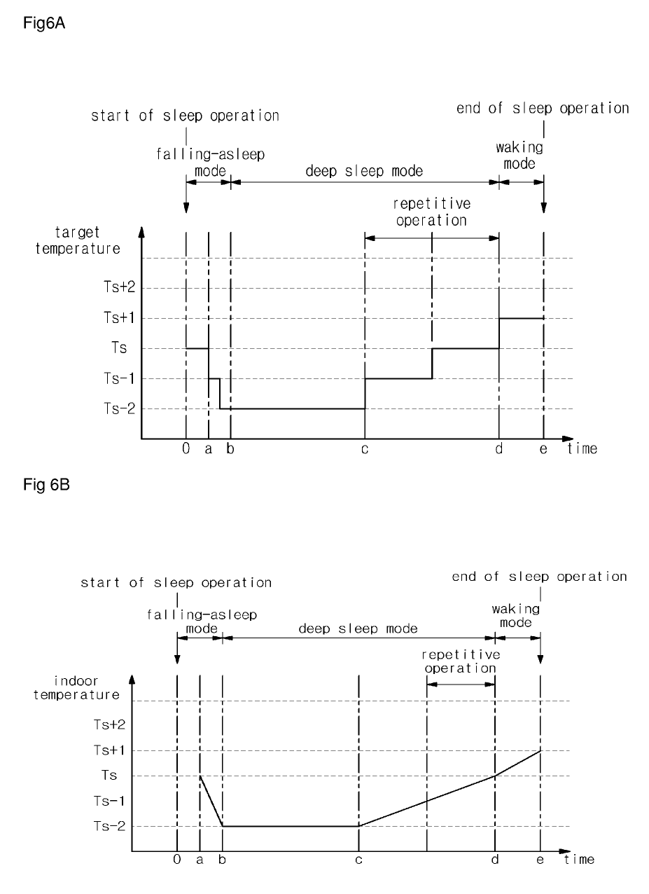

Changes in the indoor temperature according to sleep operation timing during heating operation of the air conditioner according to an embodiment of the invention will now be described with reference to FIGS. 6A and 6B.

When the sleep operation starts, the microcomputer 30 causes the air conditioner to uniformly blow out air at a target indoor temperature Ts input by the user into the room during a time interval from “0” to “a”. This causes the indoor temperature to approach Ts. Thereafter, during a time interval from “a” to “b”, the microcomputer 30 gradually decreases the temperature of discharged air to reduce the indoor temperature to “Ts−2”. The reduction in the indoor temperature decreases the skin temperature of the user to an appropriate level to minimize the activity of the temperature control system, thereby allowing the user to fall asleep.

During a time interval from “b” to “c”, the microcomputer 30 keeps the temperature of discharged air at “Ts−2” to keep the indoor temperature at “Ts−2” so that the user can maintain the healthy body/skin temperature during sleep in winter. During a time interval from “c” to “d”, the microcomputer 30 periodically increases the temperature of discharged air to gradually increase the indoor temperature to “Ts”. The gradual increase in the indoor temperature prevents a rapid increase in the body/skin temperature and the increased indoor temperature prevents a reduction in the skin temperature to allow the user to sleep soundly. Then, during a remaining time of the sleep operation, the microcomputer 30 periodically repeats an operation to reduce the temperature of discharged air back to “Ts-1” and then to increase the indoor temperature back to “Ts”, thereby allowing the body/skin temperature to be within a comfortable range.

During a time interval from “d” to “e”, the microcomputer 30 increases the temperature of discharged air to “Ts+1” to increase the indoor temperature to “Ts+1”. Since the user will wake up at the time “e”, the microcomputer 30 further increases the indoor temperature by the specific level to increase the body temperature of the user for a specific time before the time “e” (i.e., during the time interval “d” to “e”). The increased body temperature contributes to increasing the metabolic activity of the user.

As is apparent from the above description, the embodiment of the present invention provides a method to control a sleep operation of an air conditioner with a variety of advantages. For example, the indoor temperature is adjusted according to changes in the body temperature and sleep cycles of human beings, thereby allowing the user to sleep soundly.

Although an embodiment of the present invention has been shown and described, it would be appreciated by those skilled in the art that changes may be made in this embodiment without departing from the principles and spirit of the invention, the scope of which is defined in the claims and their equivalents.

1. A method to control a sleep operation of an air conditioner, the method comprising:
determining whether or not a sleep operation is activated; and
sequentially performing a plurality of sub-modes of the sleep operation if the sleep operation is activated.

2. The method according to claim 1, wherein the plurality of sub-modes include a falling-asleep mode to reduce an indoor temperature to be lower than a target indoor temperature by a first level and a waking mode to increase the indoor temperature to be higher than the target indoor temperature by a second level.

3. The method according to claim 2, wherein the plurality of sub-modes further include a deep sleep mode to increase the indoor temperature to be higher than the target indoor temperature by the first level and then to reduce the indoor temperature back to the target indoor temperature periodically during a cooling operation.

4. The method according to claim 2, wherein the plurality of sub-modes further include a deep sleep mode to increase the indoor temperature to the target indoor temperature after maintaining the indoor temperature at a level, which is lower than the target indoor temperature by the first level, during a heating operation.

5. The method according to claim 4, wherein the deep sleep mode includes repeating an operation to reduce, when the indoor temperature has reached the target indoor temperature, the indoor temperature back to a temperature, which is lower than the target indoor temperature, the indoor temperature back to a temperature, which is lower than the target indoor temperature by the second level, and then to increase the indoor temperature back to the target indoor temperature.

6. The method according to claim 3, wherein an operation duration of the deep sleep mode is determined according to a duration of the sleep operation.

7. The method according to claim 2, wherein the second level is higher than the first level during a cooling operation.

8. The method according to claim 2, wherein, in the falling-asleep mode during a cooling operation, when a sleep operation command is input, the air conditioner immediately operates with a temperature which is lower than the target indoor temperature by the first level.

9. The method according to claim 2, wherein the second level is lower than the first level during a heating operation.

10. The method according to claim 2, wherein, in the falling-asleep mode during a heating operation, when a sleep operation command is input, the air conditioner operates with the target indoor temperature for a specific period of time and then operates at a temperature which is lower than the target indoor temperature by the first level.

11. A method to control a sleep operation of an air conditioner when the air conditioner is in cooling operation, the method comprising:
maintaining an indoor temperature during a falling-asleep mode comprising maintaining the indoor temperature below a target indoor temperature until a first reference time elapses after the sleep operation starts;
increasing the indoor temperature during a deep sleep comprising increasing, after the first reference time elapses, the indoor temperature to be higher than the target indoor temperature and then to reducing the indoor temperature back to the target indoor temperature periodically; and
maintaining the indoor temperature during a waking mode comprising maintaining the indoor temperature above the target indoor temperature for the first reference time before the sleep

12. The method according to claim 11, wherein the first reference time is 1 hour.

13. The method according to claim 11, wherein the target indoor temperature is set within a range from 24° C. to 27° C.

14. The method according to claim 11, further comprising maintaining the indoor temperature below the target indoor temperature by 2° C. until the first reference time elapses from the start of the sleep operation,
increasing the indoor temperature to be 2° C. higher than the target indoor temperature and then reducing back to the target indoor temperature periodically after the first reference time elapses, and
maintaining the indoor temperature above the target indoor temperature by 2.5-3° C. for the first reference time before the sleep operation is terminated.

15. A method to control a sleep operation of an air conditioner when the air conditioner is in heating operation, the method comprising:
maintaining an indoor temperature below a target indoor temperature by a first level until a first reference time elapses after the sleep operation starts; and
increasing, after the first reference time elapses, the indoor temperature to be higher than the target indoor temperature by a second level during a remaining time of the sleep operation.

16. The method according to claim 15, wherein the target indoor temperature is set within a range from 22° C. to 25° C.

17. The method according to claim 15, wherein the first level is 2° C. and the second level is 1° C.

18. The method according to claim 4, wherein an operation duration of the deep sleep mode is determined according to a duration of the sleep operation.
